(19) United States
(12) Patent Application Publication
(10) Pub. No.: US 2025/0135677 A1
(43) Pub. Date: May 1, 2025

(54) Notching System for Electrode Sheet

(71) Applicant: LG Energy Solution, Ltd., Seoul (KR)

(72) Inventors: Zheng Hua Li, Daejeon (KR); Ki Beom Park, Daejeon (KR); Eui Seob Song, Daejeon (KR); Hyo Joon Lee, Daejeon (KR); Min Ha Yee, Daejeon (KR); Eun Ji Song, Daejeon (KR)

(73) Assignee: LG Energy Solution, Ltd., Seoul (KR)

(21) Appl. No.: 18/689,531

(22) PCT Filed: Oct. 19, 2022
(86) PCT No.: PCT/KR2022/015970

§ 371 Date: Mar. 6, 2024

(30) Foreign Application Priority Data
Oct. 19, 2021 (KR) 10-2021-0139571

(51) Int. Cl. B26F 1/12; B65H 18/10; B65H 23/04; B65H 39/16; B65H 41/00; H01M 4/04

(52) U.S. Cl. CPC B26F 1/12; B65H 18/103; B65H 23/048; B65H 39/16; B65H 41/00; B65H 2301/5152; B65H 2701/19; H01M 4/0433

(57) ABSTRACT

A notching system for an electrode sheet coated with slurry on a surface of a collector includes: an electrode unwinder from which the electrode sheet is unwound; a film unwinder from which a protective film stacked on the electrode sheet is unwound; a notching device configured to notch a non-coating portion, which is a portion that is not coated with the slurry on the electrode sheet, when provided in the state in which the protective film is stacked on the electrode sheet; and a rewinder configured to wind the notched electrode sheet.

Accordingly, the problem such as the cutting and tearing of the electrode sheet and the problem of causing the scratches due to the separation of the graphite powder from the surface of the electrode sheet may be solved.

### CROSS-REFERENCE TO RELATED APPLICATION

The present application is a national phase entry under 35 U.S.C. § 371 of International Application No. PCT/KR2022/015970 filed on Oct. 19, 2022 which claims the benefit of priority based on Korean Patent Application No. 10-2021-0139571, filed on Oct. 19, 2021, all contents of which are incorporated herein by reference.

### TECHNICAL FIELD

The present disclosure relates to a notching system for an electrode sheet in which slurry is applied to a surface of a collector made of a thin metal, and more particularly, to a notching system for an electrode sheet, which is capable of preventing breakage of the electrode sheet or surface scratches caused by foreign substances (graphite powder) when notching processing is performed.

### BACKGROUND ART

Lithium secondary that are batteries chargeable/dischargeable and lightweight and have high output densities are being widely used as energy sources for various devices.

In addition, lithium secondary batteries have attracted considerable attention as power sources for hybrid electric vehicles (HEVs), plug-in hybrid electric vehicles (PHEVs), battery electric vehicles (BEVs), and electric vehicles (EVs), which have been developed to solve limitations, such as air pollution and green-house gases, caused by existing internal-combustion engine vehicles that use fossil fuels, such as, gasoline and diesel vehicles.

In general, such a secondary battery has a structure comprising an electrode assembly having a structure in which electrodes (a negative electrode and a positive electrode) and a separator are alternately stacked, an electrolyte allowing ions to move to the electrodes, and a case in which the electrode assembly and the electrolyte are accommodated.

Also, a process of manufacturing the secondary battery is largely classified into an electrode plate process of manufacturing each of a positive electrode and a negative electrode, an assembly process of inserting an electrode assembly together with an electrolyte into a case after the electrode assembly is manufactured by using the positive electrode and the negative electrode, and a formation process of activating movement of ions of the electrode assembly. Each of the electrode plate process, the assembly process, and the formation process is divided into detailed processes.

Here, the electrode plate process comprises a mixing process of adding and mixing an active material, a conductive material, and a binder to prepare slurry, a coating process of applying the mixed slurry on the collector, a press process of pressing the slurry onto a surface of the collector, and a process (notching process) of shearing the electrode sheet so that the electrode sheet in which the slurry adheres to the surface of the collector is cut to a proper size to form an electrode tab (or cut to a proper size and simultaneously form an electrode tab).

Here, a coating portion to which the slurry is applied (coated) and a non-coating portion to which the slurry is not applied are formed on the collector. That is, the electrode sheet has a structure in which the slurry is applied in a narrower width than the collector, but the slurry is not applied to an intermediate portion along a longitudinal direction so that the non-coating portion is formed between the coating portions that are disposed at both sides thereof (see FIG. 3).

In addition, the notching process is performed by punching the electrode sheet using a notching device 7 so that the electrode tab T (see FIG. 3) remains, and remaining portion is cut. The notching device 7 includes a lower mold disposed below the electrode sheet 1 and an upper mold disposed above the electrode sheet 1, and the upper mold descends to contact the non-coating portion of the electrode sheet 1 to process the electrode tab T at the non-coating portion.

Therefore, as illustrated in FIG. 1, in which the notching system according to the related art is simplified, the notching system of the electrode sheet according to the related art includes an electrode unwinder 5 from which the electrode sheet 1 is unwound to be continuously supplied, a notching device 7 disposed in a path, along which the electrode sheet 1 is transferred, to notch the electrode tab at the non-coating portion, and a rewinder 8 winding the notched electrode sheet la. In addition, rollers 6 for changing the transfer path of the electrode substrate 1 may be provided.

When the electrode sheet 1 is a negative electrode, the collector is made of copper and has a structure in which negative electrode slurry is applied, and when the electrode sheet 1 is a positive electrode, the collector is made of aluminum, and positive electrode slurry is applied.

Here, in the case of the positive electrode, when the notching process is performed, there is a problem in that tearing, cutting (disconnection), or damage occurs due to insufficient elasticity of a material of the collector made of aluminum. Such the tearing, cutting, or breakage delays a processing time of the notching processing, which is a continuous process and increases material loss due to disposal.

In addition, in the case of the negative electrode, graphite in the form of powder is contained in the negative electrode slurry. In addition, there is a problem in that graphite is separated from the surface of the electrode sheet 1 to adhere to the plurality of rollers 6. Graphite accumulated by adhering to the surfaces of the rollers 6 may cause scratches on the surface of the electrode sheet 1 while the electrode sheet 1 is transferred.

### DISCLOSURE OF THE INVENTION

### Technical Problem

Therefore, a main aspect of the present invention is to provide a notching system for an electrode sheet, which is capable of preventing a problem of tearing, cutting, or damage of the electrode sheet and solving a problem of scratches due to smearing on the surface of the electrode sheet.

### Technical Solution

An aspect of the present invention for achieving the object as described above includes a notching system for an electrode sheet coated with slurry on a surface of a collector, the notching system including: an electrode unwinder from which the electrode sheet is unwound; a film unwinder from which a protective film stacked on the electrode sheet is unwound; a notching device configured to notch a non-coating portion, which is a portion that is not coated with the slurry on the electrode sheet, when provided in the state in which the protective film is stacked on the electrode sheet; and a rewinder configured to wind the notched electrode sheet.

The notching system may further include a tension roller disposed in a path along which the electrode sheet and the protective film are transferred, wherein the tension roller may be slid in a predetermined direction to apply a pressure to the electrode sheet and the protective film so that tension is maintained within a predetermined range.

The protective film may have a width greater than that of the electrode sheet so that a portion of the protective film protrudes from each of both sides of the electrode sheet when the protective film is stacked on the electrode sheet.

The electrode sheet may be a positive electrode sheet coated with positive electrode slurry on a surface of a positive electrode collector, and the protective film may be stacked to be disposed on a bottom surface of the positive electrode sheet when the positive electrode sheet enters the notching device.

The electrode sheet may be a negative electrode sheet coated with negative electrode slurry on a surface of a negative electrode collector, and the film unwinder may include: a first film unwinder from which a protective film stacked on a bottom surface of the electrode sheet is unwound; and a second film unwinder from which a protective film stacked on a top surface of the electrode sheet is unwound so that the protective film is stacked on each of the top surface and the bottom surface of the negative electrode sheet when the negative electrode sheet enters the notching device.

The protective film may have a width greater than that of the electrode sheet so that a portion of the protective film protrudes from each of both sides of the electrode sheet when the protective film is stacked on the electrode sheet, and the protective film stacked on the bottom surface of the electrode sheet and the protective film stacked on the top surface of the electrode sheet may be aligned with each other so that both ends of the protective films are matched along a width direction with the electrode sheet therebetween.

The non-coating portion may be formed to be disposed at a center region along a longitudinal direction of the electrode sheet, the electrode sheet and the protective film may be notched so that the non-coating portion is cut in the notching device so as to be divided into a first processing body and a second processing body, and the rewinder may include: a first rewinder around which the first processing body is wound; and a second rewinder around which the second processing body is wound.

One of the first rewinder and the second rewinder may be disposed at a height lower than the notching device, and the other one may be disposed at a height higher than the notching device.

The notching device may include: a lower mold disposed below the electrode sheet; and an upper mold disposed above the electrode sheet, wherein, when the electrode sheet is disposed between the lower mold and the upper mold, the upper mold or the lower mold may be configured to contact the non-coating portion of the electrode sheet so that the electrode sheet is processed to be molded in a predetermined shape.

The notching system may further include a film collecting device configured to separate and collect the protective film from the notched electrode sheet.

### Advantageous Effects

In an aspect of the present invention having the configuration as described above, since the notching processing is performed in the state in which the electrode sheet and the protective film are stacked, the problem such as the cutting and tearing of the electrode sheet and the problem of causing the scratches due to the separation of the graphite powder from the surface of the electrode sheet may be prevented or minimized.

That is, the protective sheet may disperse the tension applied to the electrode sheet to restrict the cutting, and the surface of the electrode sheet may be covered by the protective film to fundamentally prevent the graphite powder from being separated.

In addition, the tension roller may be further provided to adjust the tension applied to the electrode sheet being transferred.

The protective film may have the width greater than that of the electrode sheet so that a portion of the protective film protrudes from each of both the sides of the electrode sheet when the protective film is stacked with the electrode sheet. Thus, when the electrode sheet and the protective film are attached to each other, even though the electrode sheet is separated from the regular position, the possibility of the separation of the protective film may be reduced.

The electrode sheet may be divided into the first processing body and the second processing body after being subjected to the notching processing and then collected from each of the first rewinder and the second rewinder so as to be collected for each processed product.

The film collecting device that collects the protective film from the notched electrode sheet may be further provided, and thus, the protective film may be provided in the detached state.

### BRIEF DESCRIPTION OF THE DRAWINGS

FIG. 1 is a schematic view of a notching system according to a related art.

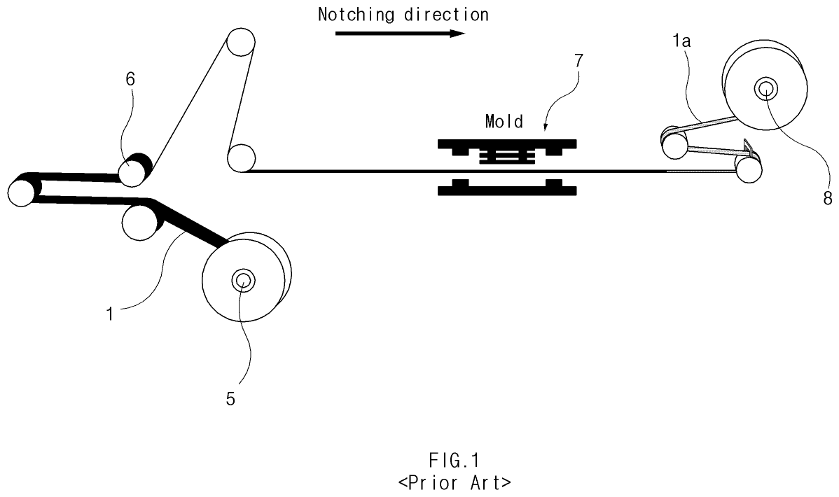

FIG. 2 is a schematic view of a notching system according to a first embodiment of the present invention.

FIG. 3 is a view illustrating a process in which notching process is performed in a notching device and an enlarged view of a notched portion.

FIG. 4 is a schematic view of a notching system according to a second embodiment of the present invention.

### DETAILED DESCRIPTION

Hereinafter, preferred embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein.

In order to clearly describe an embodiment of the present invention, parts irrelevant to the description are omitted, and the same reference numerals are assigned to the same or similar components throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

An embodiment of the present invention relates to a notching system of an electrode sheet, which is capable of preventing or minimizing an occurrence of cutting and scratching of the electrode sheet. Hereinafter, embodiments according to the present invention will be described in more detail with reference to the accompanying drawings.

### First embodiment

In an embodiment of the present invention, a notching system capable of preventing an electrode sheet 1 from being cut while a notching process is performed in a state in which a protective film 2 is stacked on one surface of the electrode sheet 1 is provided as a first embodiment.

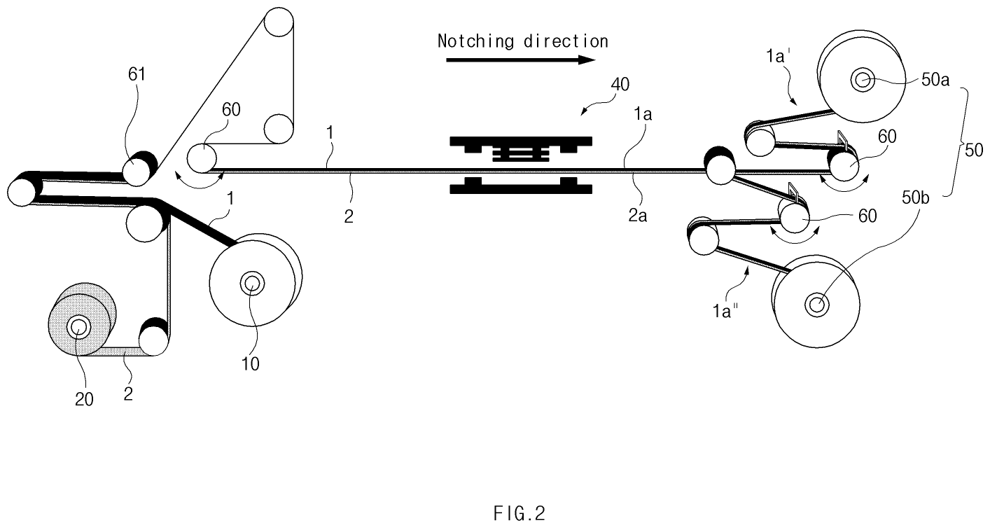

Referring to FIG. 2 that illustrates the simplified notching system according to the first embodiment of the present invention, the notching system provided in this embodiment includes an electrode unwinder 10, a film unwinder 20, and a notching device 40, and a rewinder 50.

The electrode unwinder 10 rotates in an unwinding direction in a state in which the electrode sheet 1 that is coated with slurry on a surface of a collector, so as to continuously unwind the electrode sheet 1.

Although the electrode sheet 1 provided in this embodiment is used for a negative electrode sheet, since an aspect of the present invention is to relatively simplify a process, reduce production costs, and prevent the electrode sheet 1 from being cut or damaged, it is also preferable that the electrode sheet is used for a positive electrode sheet. That is, the electrode sheet 1 provided in this embodiment is provided by applying positive electrode slurry on a surface of a positive electrode collector made of aluminum.

The protective film 2 is wound around the film unwinder 20. The protective film 2 is wound to have a length greater than that of the electrode sheet 1 so that the electrode sheet 1 is continuously unwound while the unwinding of the electrode sheet 1 is continued.

In addition, the protective film 2 and the electrode sheet 1 are unwound from the film unwinder 20 and the electrode unwinder 10, respectively, and then meet each other in a transfer path, so as to stack (i.e. match) on each other and are transferred in the stacked state.

That is, as illustrated in FIG. 2, the protective film 2 and the electrode sheet 1 are stacked before passing through a roller that passes first in the transfer path among a plurality of rollers 61. Then, the protective film 2 and the electrode sheet 1 are in close contact with each other while each of the rollers moves.

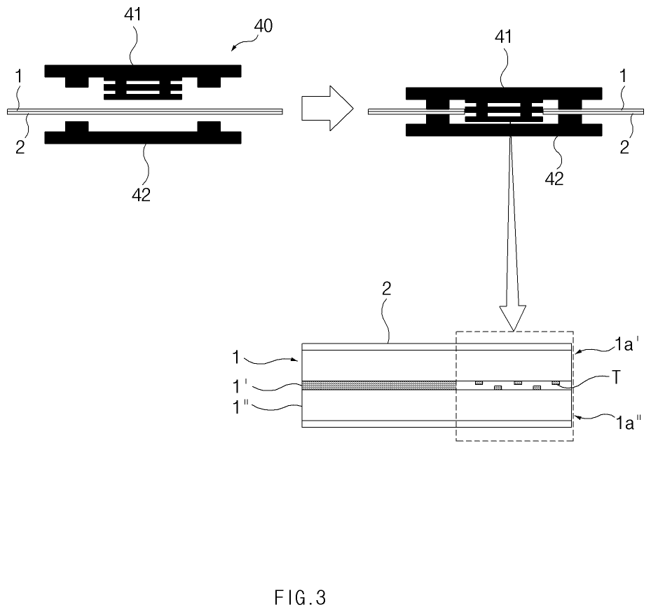

Here, as illustrated in FIG. 3, which illustrates a process in which the notching process is performed in the notching device 40 and an enlarged view of a notched portion, the protective film 2 has a width that is slightly greater than that of the electrode sheet 1 so that a portion of the protective film 2 protrudes to each of both sides of the electrode sheet 1 when the protective film 2 is stacked on the electrode sheet 1.

That is, referring to FIG. 3, when the electrode sheet 1 provided in an embodiment of the present invention is viewed from top to bottom, a coating portion 1″ coated with slurry and a non-coating portion 1′ that is not coated with the slurry are formed on the surface of the collector. As illustrated in the drawing, the non-coating portion 1′ is formed in a longitudinal direction between the coating portions 1″ disposed at both the sides and coated with the slurry.

Thus, the protective film 2 protrudes further by a predetermined length from each of ends of the coating portions 1″ disposed at both the sides of the collector in a width direction (vertical direction in FIG. 3).

The protective film 2 is transferred with the electrode sheet 1 through the plurality of rollers 61 in the stacked state as illustrated in FIG. 3, and at least one or more of the plurality of rollers 61 are provided as tension rollers 60 that are rotatable and slidable.

That is, each of the tension rollers 60 is disposed in the path along which the electrode sheet 1 and the protective film 2 are transferred in the stacked state and is slid to be reciprocated in a predetermined direction (for example, a vertical direction or a left and right direction in FIG. 2) to apply a pressure to the electrode sheet 1 and the protective film 2 so that tension is maintained within a predetermined range.

While being transferred by passing through the plurality of rollers 61, transfer directions within the transfer path of the electrode sheet 1 and the protective film 2 are changed, but enter the notching device 40 in a horizontal state. Here, the protective film 2 enters in a state of being disposed on a bottom surface of the electrode sheet 1. That is, in FIG. 2, in the state in which the protective film 2 is disposed at a lower side, and the electrode sheet 1 is disposed at an upper side, the protective film 2 and the electrode sheet 1 enter the notching device 40.

Thus, when the electrode sheet 1 and the protective film 20 are provided in the state of being stacked on each other, the notching device 40 performs the notching processing on the non-coating portion 1′ of the electrode sheet 1, which is not coated with the slurry.

The notching device 40 includes a lower mold 42 disposed below the electrode sheet 1 and an upper mold 41 disposed above the electrode sheet 1. In addition, when the electrode sheet 1 is disposed between the lower mold 42 and the upper mold 41, as illustrated in FIG. 3, since the upper mold 41 and the lower mold 42 are slid vertically to contact (punch) the electrode sheet 1, thereby performing the notching processing so that the electrode tab T is formed in a predetermined shape on the non-coating portion 1′ of the electrode sheet 1.

When only the upper mold 41 descends in a state in which the lower mold 42 is fixed, the upper mold 41 contacts the electrode sheet first to prevent or minimize deterioration in processibility due to attachment of the protective film 2.

The upper mold 41 and the lower mold 42 contact the non-coating portion 1′ so that the electrode tab remains, and remaining portion is removed. Thus, as illustrated in FIG. 3, the electrode tab T is formed at both the sides of the non-coating portion, and the electrode sheet 1 and the protective film 2 are divided into a first processing body 1a′ and a second processing body 1a″ in the notching device 40 in a longitudinal direction.

In addition, the rewinder 50 individually winds the

first and second processing bodies 1a′ and 1a″ of the notched electrode sheet 1.

That is, the rewinder 50 includes a first rewinder 50a around which the first processing body 1a′ is wound and a second rewinder 50b around which the second processing body 1a″ is wound.

One of the first rewinder 50a and the second rewinder 50b is disposed at a height lower than the notching device 40, and the other is disposed at a height higher than the notching device 40, and thus, the first rewinder 50a and the second rewinder 50b independently wind the first processing body 1a′ and the second processing body 1a″, respectively. Here, the tension roller 60 and the rollers that are changed in the transfer direction along the transfer path may be selectively disposed while the first processing body 1a′ and the second processing body 1a″ move to the first rewinder 50a and the second winder 50b, respectively.

The first processing body 1a′ and the second processing body 1a″ are wound in the state in which the protective film 2 is stacked on the electrode sheet 1. Thus, a film collecting device (not shown) that separates and collect the protective film 2 from the electrode sheet 1 before the first processing body 1a′ and the second processing body 1a″ is put into the next process may be added.

The film collecting device may wind only the protective film 2 to be provided in the separated state when the first processing body 1a′ and the second processing body 1a″, which are wound around the first rewinder 50a and the second rewinder 50b, are separated. The film collecting device may have a structure that rotates at the same time together with the first rewinder 50a and the second rewinder 50b to wind the first processing body 1a′ and the second processing body 1a″ in a state in which an end of the protective film 2 is fixed, thereby separating only the protective film 2, or may have a structure of another known separation device.

Alternatively, the film collecting device may be disposed before reaching the first rewinder 50a and the second rewinder 50b to remove the protective film 2 from the first processing body 1a′ and the second processing body 1a″, which are notched, and be configured to wind only the electrode sheet 1 around the first rewinder 50a and the second rewinder 50b.

### Second embodiment

In an embodiment of the present invention, a notching system that performs notching processing in a state in which protective films 2 and 3 are stacked on both surfaces of an electrode sheet 1 to prevent scratches caused by graphite powder is provided as a second embodiment.

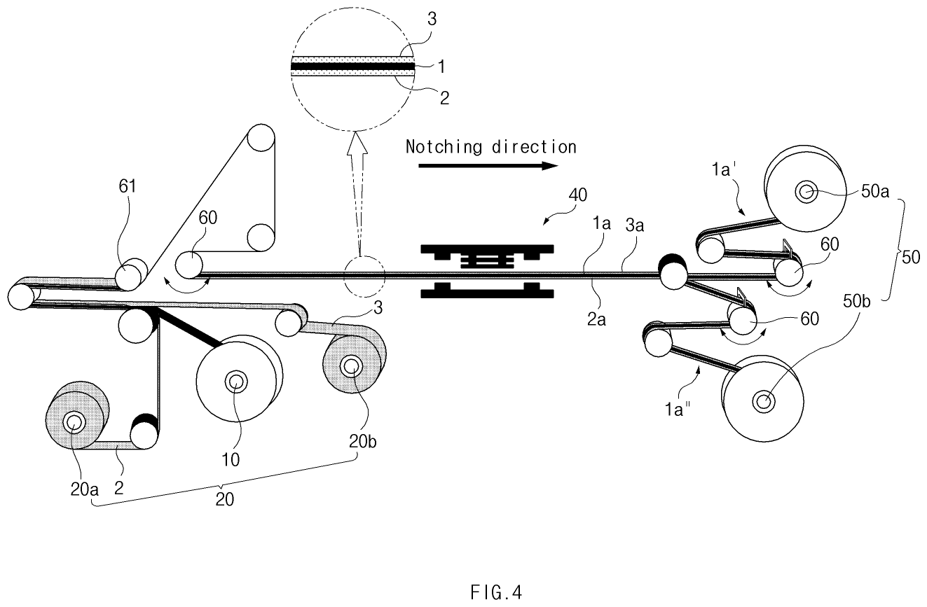

Referring to FIG. 4 that illustrates the simplified notching system according to the second embodiment of the present invention, the notching system provided in this embodiment also include an electrode unwinder 10, a film unwinder 20, and a notching device 40, and a rewinder 50.

The electrode sheet 1 provided in this embodiment may also be used for a positive electrode sheet, but if an aspect of the present invention is to only prevent cutting and breaking, since it is sufficient to provide the protective film 2 at only one side, the notching system according to the first embodiment may be more preferably used in terms of production costs. Thus, since the purpose of this embodiment is to prevent the scratches caused by scattering or smearing of graphite powder on the electrode sheet 1, it is preferable to use a negative electrode sheet. That is, the electrode sheet 1 provided in this embodiment is provided by applying negative electrode slurry on a surface of a negative electrode collector made of copper.

The film unwinder 20 includes a first film unwinder 20a, from which the protective film 2 stacked on a bottom surface of the electrode sheet 1 is unwound, and a second film unwinder 20b, from which a protective film 3 stacked on a top surface of the electrode sheet 1 is wound (here, the top surface and the bottom surface are defined based on a vertical direction when entering a notching device).

The protective films 2 and 3 wound around the first film unwinder 20a and the second film unwinder 20b may be basically provided to have the same material and the same thickness, but the protective films 2 and 3, which are contacted when being put into the notching device so as to be notched, may have a different thickness or be made of a different material so as not to affect processability or to minimize the effect thereof.

Each of the protective films 2 and 3 respectively provided on the first film unwinder 20a and the second film unwinder 20b may be wound with a length greater than that of the electrode sheet 1 and thus may be unwound without being disconnected while the electrode sheet is continuously unwound.

In addition, the protective films 2 and 3 and the electrode sheet 1 are unwound from the first film unwinder 20a, the second film unwinder 20b, and the electrode unwinder 10, respectively, and then meet each other in a transfer path, so as to stack on each other and are transferred in the stacked state.

That is, as illustrated in FIG. 4, the protective films 2 and 3 are stacked before passing a roller that passes first in the transfer path among a plurality of rollers 61. Then, the protective films 2 and 3 are in close contact with each other on both surfaces of the electrode sheet 1 while each of the rollers 61 moves.

Like the first embodiment, each of the protective films 2 and 3 has a width greater than that of the electrode sheet 1 so that portions of the protective films 2 and 3 protrude from both sides of the electrode sheet 1, respectively, when the protective films 2 and 3 are stacked with the electrode sheet 1. Here, the protective films 2 and 3 stacked on one side and the other side of the electrode sheet 1, respectively are provided to have the same width. In addition, the protective film 2 stacked on a bottom surface of the electrode sheet 1 and the protective film 3 stacked on a top surface of the electrode sheet 1 are aligned so that both ends of the protective films 2 and 3 are matched along a width direction with the electrode sheet 1 therebetween.

At least one of the protective films 2 and 3 may protrude along the width direction from the electrode sheet 1 so as to block movement of the electrode sheet 1 during the notching process, and thus, an adhesive may be additionally applied to a portion at which the protective films 2 and 3 face each other to adhere to each other in a state of being aligned with another protective film. Thus, since the electrode sheet 1 is notched in the state in which the movement between the protective films 2 and 3 is prevented, a defect rate may be reduced, and more precise notching may be performed.

In this embodiment as well, a non-coating portion 1′ is formed to be disposed at a center region in a longitudinal direction of the electrode sheet 1, and the electrode sheet 1 and the protective films 2 and 3 are notched so that the non-coating portion 1′ is cut in the notching device 40 and thus, the electrode sheet 1 is divided into a first processing body 1a′ and a second processing body 1a″. In addition, the rewinder 50 also includes a first rewinder 50a around which the first processing body 1a′ is wound and a second rewinder 50b around which the second processing body 1a″ is wound so as to wind the first processing body 1a′ and the second processing body 1a″, respectively.

Furthermore, as described above, the notching device 40 provided in this embodiment also has a structure including a lower mold 42 disposed below the electrode sheet 1 and an upper mold 41 disposed above the electrode sheet 1 to contact the non-coating portion 1′, thereby molding an electrode tab T. In addition, a film collecting device (not shown) may be further provided to separate and collect the protective films 2 and 3 from the notched electrode sheet 1. Here, the film collecting device may have a structure coupled to the upper mold 41 or the lower mold 42 and may be configured to peel off the protective films 2 and 3 while passing through the notching device 40.

In an embodiment of the present invention having the configuration as described above, since the notching processing is performed in the state in which the electrode sheet 1 and the protective film are stacked, the problem such as the cutting and tearing of the electrode sheet 1 and the problem of causing the scratches due to the separation of the graphite powder from the surface of the electrode sheet 1 may be solved.

That is, the protective sheet may disperse the tension applied to the electrode sheet to restrict the cutting, and the surface of the electrode sheet may be covered by the protective film to fundamentally prevent the graphite powder from being separated.

In addition, the tension roller may be further provided to adjust the tension applied to the electrode sheet being transferred.

The protective film may have the width greater than that of the electrode sheet so that the portion of the protective film protrudes from each of both the sides of the electrode sheet when the protective film is stacked with the electrode sheet, and thus, when the electrode sheet and the protective film are attached to each other, even though the electrode sheet is separated from the regular position, the possibility of the separation of the protective film may be reduced.

The electrode sheet 1 may be divided into the first processing body 1a′ and the second processing body 1a″ after being subjected to the notching processing and then collected from each of the first rewinder and the second rewinder so as to be collected for each processed product.

The film collecting device that collects the protective film from the notched electrode sheet may be further provided, and thus, the protective film may be collected in the detached state.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

1: Electrode sheet
1a: Notched electrode sheet
2, 3: Protective film
2a, 3a: Notched bottom protective film, Notched Top protective film
10: Electrode unwinder
20: Film unwinder
20a: First film unwinder
20b: Second film unwinder
40: Notching device
50: Rewinder

1. A notching system for an electrode sheet on a surface of a collector, the notching system comprising:
an electrode unwinder configured to unwind the electrode sheet;
a film unwinder configured to unwind a protective film to be stacked on the electrode sheet;
a notching device configured to notch a non-coating portion of the electrode sheet in a state in which the protective film is stacked on the electrode sheet, wherein the non-coating portion is a portion of the electrode sheet that is not coated with a slurry, and wherein the notching of the non-coating portion of the electrode sheet forms a notched electrode sheet; and
a rewinder configured to wind the notched electrode sheet.

2. The notching system of claim 1, further comprising:
a tension roller disposed in a transfer path along which the electrode sheet and the protective film are configured to be transferred,
wherein the tension roller is configured to slide in a predetermined direction, so as to apply a pressure to the electrode sheet and the protective film, so that a tension of the electrode sheet is maintained within a predetermined range.

3. The notching system of claim 1, wherein the protective film has a width greater than that of the electrode sheet so that a portion of the protective film protrudes from each of both sides of the electrode sheet in a width direction in the state in which the protective film is stacked on the electrode sheet.

4. The notching system of claim 1, wherein the electrode sheet is a positive electrode sheet coated with positive electrode slurry on a surface of a positive electrode collector, and the protective film is disposed on a bottom surface of the positive electrode sheet in a state in which the positive electrode sheet enters the notching device.

5. The notching system of claim 1, wherein the electrode sheet is a negative electrode sheet coated with negative electrode slurry on a surface of a negative electrode collector, and
wherein the film unwinder comprises:
a first film unwinder configured to unwind the a protective film to be stacked on a bottom surface of the electrode sheet; and
a second film unwinder configured to unwind the protective film to be stacked on a top surface of the electrode sheet so that the protective film is stacked on each of the top surface and the bottom surface of the negative electrode sheet in the state in which the negative electrode sheet enters the notching device.

6. The notching system of claim 5, wherein the protective film has a width greater than that of the electrode sheet so that a portion of the protective film protrudes from each of both sides of the electrode sheet in a width direction in the state in which the protective film is stacked on the electrode sheet, and
the protective film stacked on the bottom surface of the electrode sheet and the protective film stacked on the top surface of the electrode sheet are aligned with each other so that both ends of the protective films are matched along the width direction with the electrode sheet therebetween.

7. The notching system of claim 1, wherein the non-coating portion is disposed at a center region of the electrode sheet along a longitudinal direction of the electrode sheet,
wherein the notching device is configured to cut the non-coating portion, so as to be divided into a first processing body and a second processing body, wherein the electrode sheet and the protective film are in a notched state, and
wherein the rewinder comprises:
a first rewinder around which the first processing body is configured to be wound; and
a second rewinder around which the second processing body is configured to be wound.

8. The notching system of claim 7, wherein any one of the first rewinder and the second rewinder is disposed at a height lower than the notching device, and the other one is disposed at a height higher than the notching device.

9. The notching system of claim 1, wherein the notching device comprises:
a lower mold disposed below the electrode sheet; and
an upper mold disposed above the electrode sheet,
wherein, in a state in which the electrode sheet is disposed between the lower mold and the upper mold, at least one of the upper mold and the lower mold is configured to contact the non-coating portion of the electrode sheet, so as to process and mold the electrode sheet into a predetermined shape.

10. The notching system of claim 1, further comprising a film collecting device configured to separate and collect the protective film from the notched electrode sheet.
